(19) United States
(12) Patent Application Publication
(10) Pub. No.: US 2024/0128469 A1
(43) Pub. Date: Apr. 18, 2024

(54) MEMBRANE ELECTRODE ASSEMBLY

(71) Applicant: TOYOTA JIDOSHA KABUSHIKI KAISHA, Toyota-shi (JP)

(72) Inventors: Shunsuke TAKAHASHI, Toyota-shi (JP); Noriyuki KITAO, Toyota-shi (JP)

(73) Assignee: TOYOTA JIDOSHA KABUSHIKI KAISHA, Toyota-shi (JP)

(21) Appl. No.: 18/483,979

(22) Filed: Oct. 10, 2023

(30) Foreign Application Priority Data
Oct. 12, 2022 (JP) 2022-164146

(51) Int. Cl. H01M 4/86; H01M 8/1004

(52) U.S. Cl. CPC H01M 4/8663; H01M 8/1004; H01M 2008/1095

(57) ABSTRACT

An object of the present disclosure is to provide a membrane electrode assembly excellent in power generation performance and durability. This embodiment is a membrane electrode assembly. The membrane electrode assembly includes a solid polymer electrolyte membrane, an anode catalyst layer, and a cathode catalyst layer. The anode catalyst layer is disposed on one surface of the solid polymer electrolyte membrane. The cathode catalyst layer is disposed on the other surface of the solid polymer electrolyte membrane. The anode catalyst layer at least contains an electrode catalyst, an ionomer, a metal ion, and a host compound. The ionomer has sulfonate group. The metal ion is selected from cerium ion or manganese ion. The host compound allows forming an inclusion compound with the metal ion. The host compound has a molecular weight of 300 or more.

### CROSS REFERENCE TO RELATED APPLICATIONS

The present application claims priority from Japanese patent application JP 2022-164146 filed on Oct. 12, 2022, the entire content of which is hereby incorporated by reference into this application.

### BACKGROUND

### Technical Field

The present disclosure relates to a membrane electrode assembly.

### Background Art

A solid polymer fuel cell, which is a fuel cell that generates electricity using an electrochemical reaction between a fuel gas and an oxidant gas, has attracted attention. Since the solid polymer fuel cell allows operation at room temperature while its output density is high, the solid polymer fuel cell has been actively studied as a configuration appropriate for automobile application and the like.

The solid polymer fuel cell generally includes a membrane electrode assembly (also referred to as a “MEA”) that includes a solid polymer electrolyte membrane as an electrolyte membrane, an anode catalyst layer disposed on one surface of the solid polymer electrolyte membrane, and a cathode catalyst layer disposed on the other surface of the solid polymer electrolyte membrane. The anode catalyst layer functions as a fuel electrode, and the cathode catalyst layer functions as an air electrode. Gas diffusion layers are further disposed on both surfaces of the MEA in some cases, and this configuration is referred to as a membrane electrode gas diffusion layer assembly (also referred to as a “MEGA”).

The electrodes each include a catalyst layer, and the catalyst layer generates an electrode reaction by an electrode catalyst contained in the catalyst layer. Since a three-phase interface in which three phases of an electrolyte, a catalyst, and a reaction gas coexist is necessary for generation of the electrode reaction, the catalyst layer generally contains the catalyst and the electrolyte. The gas diffusion layer is a layer to supply the reaction gas to the catalyst layer and to give and receive electrons, and a porous material having electron conductivity is used for the gas diffusion layer.

Here, in the solid polymer fuel cell, there may be a case where hydrogen peroxide (H₂O₂) is generated from water and oxygen and hydroxyl radical (·OH) is generated from the hydrogen peroxide in the catalyst layer during electric generation. The hydrogen peroxide and the hydroxyl radical cause deterioration of electrolyte resin, such as an ionomer, contained in the solid polymer electrolyte membrane and the catalyst layer.

Therefore, a technique that contains a radical quenching agent, such as a cerium ion, in a MEA to render hydrogen peroxide radical generated during electric generation of a fuel cell harmless has been proposed. Rendering hydrogen oxide radical harmless is, for example, a reaction to water from the hydrogen peroxide radical.

For example, Vo Dinh Cong Tinh, et al, “Enhancement of oxidative stability of PEM fuel cell by introduction of HO radical scavenger in Nafion ionomer,” Journal of Membrane Science 613 (2020) 118517 discloses a membrane electrode assembly (MEA) in which a coordinated complex of 18-crown-6-ether/cerium ion (CRE/Ce) is embedded into a Nafion ionomer between a catalyst and a membrane. It is described that Ce plays a role of capturing HO-radical, and CRE reduces elution of the cerium ion from the MEA during cell operation (ABSTRACT and the like).

### SUMMARY

As described above, Vo Dinh Cong Tinh, et al, “Enhancement of oxidative stability of PEM fuel cell by introduction of HO radical scavenger in Nafion ionomer,” Journal of Membrane Science 613 (2020) 118517 discloses an anode catalyst layer containing the cerium ion as the radical quenching agent and 18-crown-6-ether. One problem of the cerium ion is a decrease in durability in association with a decrease in concentration due to movement of ions. However, Vo Dinh Cong Tinh, et al, “Enhancement of oxidative stability of PEM fuel cell by introduction of HO radical scavenger in Nafion ionomer,” Journal of Membrane Science 613 (2020) 118517 describes that the addition of 18-crown-6-ether can reduce elution of the cerium ions to outside the MEA.

However, it has been proved from examination using a membrane electrode assembly including an anode catalyst layer containing 18-crown-6-ether that a decrease in performance was recognized, and there is a room for improvement in power generation performance and durability.

The present disclosure provides a membrane electrode assembly excellent in power generation performance and durability.

Through serious examination to solve the problem, the present inventors have found that the reason for the decrease in performance is that the 18-crown-6-ether contained in the anode catalyst layer transfers to a cathode catalyst layer to poison a cathode catalyst or to decrease proton conductivity in an ionomer of a cathode. Therefore, the present inventors advanced further examination, and have found that use of a host compound having a predetermined value or more of molecular weight allows suppressing transfer of the host compound to a cathode catalyst layer, and as a result, the decrease in performance can be suppressed, thus completing the present disclosure.

Aspect examples of this embodiment are as follows.
(1) A membrane electrode assembly comprises a solid polymer electrolyte membrane, an anode catalyst layer, and a cathode catalyst layer. The anode catalyst layer is disposed on one surface of the solid polymer electrolyte membrane. The cathode catalyst layer is disposed on the other surface of the solid polymer electrolyte membrane. The anode catalyst layer at least contains an electrode catalyst, an ionomer, a metal ion, and a host compound. The ionomer has sulfonate group. The metal ion is selected from cerium ion or manganese ion. The host compound allows forming an inclusion compound with the metal ion. The host compound has a molecular weight of 300 or more.
(2) The membrane electrode assembly according to (1), in which the host compound may have a ring structure.
(3) The membrane electrode assembly according to (2), in which a number of ring members of the ring structure may be 15 or more.
(4) The membrane electrode assembly according to (3), in which the host compound may be a crown ether compound.
(5) The membrane electrode assembly according to (4), in which the host compound may be a crown ether compound having an aromatic ring or an aliphatic ring.
(6) The membrane electrode assembly according to (5), in which the crown ether compound is at least one compound selected from the group consisting of dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, dicyclohexano-24-crown-8-ether, and compounds in which an aromatic ring or an aliphatic ring of these compounds is substituted by at least one substituent selected from a halogen atom, a hydroxy group, an amino group, a nitro group, a formyl group, an alkyl group having 1 to 6 carbon atoms, a hydroxyalkyl group having 1 to 6 carbon atoms, a carboxyalkyl group having 2 to 7 carbon atoms, and an aryl group having 6 to 14 carbon atoms.
(7) The membrane electrode assembly according to any one of (1) to (6), in which the ionomer may be a perfluoro sulfonic acid polymer.
(8) The membrane electrode assembly according to any one of (1) to (7), in which content of the host compound may be from 0.4 to 5.0 mol per 1 mol of the metal ion.
(9) The membrane electrode assembly according to any one of (1) to (8), in which at least a part of the host compound and the metal ion may form an inclusion compound.
(10) A solid polymer fuel cell comprising the membrane electrode assembly according to any one of (1) to (9).

The present disclosure allows providing a membrane electrode assembly excellent in power generation performance and durability.

### BRIEF DESCRIPTION OF THE DRAWINGS

FIG. 1 is a schematic cross-sectional view for describing an exemplary configuration of a membrane electrode assembly and a solid polymer fuel cell according to this embodiment, and is a cross-sectional view of a main part of a fuel cell 10 as an example.

### DETAILED DESCRIPTION

This embodiment is a membrane electrode assembly. The membrane electrode assembly includes: a solid polymer electrolyte membrane; an anode catalyst layer disposed on one surface of the solid polymer electrolyte membrane; and a cathode catalyst layer disposed on the other surface of the solid polymer electrolyte membrane. The anode catalyst layer at least comprises an electrode catalyst, an ionomer having sulfonate group, a metal ion selected from cerium ion or manganese ion, and a host compound capable of forming an inclusion compound with the metal ion. The host compound has a molecular weight of 300 or more.

This embodiment allows providing the membrane electrode assembly excellent in power generation performance and durability. Since the ionomer having the sulfonate group used in the anode catalyst layer is excellent in ion conductivity, it can contribute to high power generation efficiency. However, the ionomer having the sulfonate group is decomposed by hydrogen peroxide radical generated in the membrane electrode assembly. The decomposition of the ionomer leads to deterioration of the anode catalyst layer. Additionally, as the solid polymer electrolyte membrane, a proton conductive ion exchange membrane is used, and the solid polymer electrolyte membrane is also decomposed by the hydrogen peroxide radical. The decomposition of the solid polymer electrolyte membrane decreases a gas barrier property and increases an amount of cross leakage, leading to a decrease in performance. Note that it has been advocated that as the main mechanism of generating hydrogen peroxide, hydrogen of an anode and oxygen that has passed through a membrane from a cathode react on an anode catalyst to generate hydrogen peroxide. In this embodiment, cerium ion and/or manganese ion that functions as a radical quenching agent is added in the anode catalyst layer. Since the hydrogen peroxide radical can be captured by the cerium ion and/or the manganese ion in the anode catalyst layer, which is possibly the source of generating the hydrogen peroxide, and rendered harmless, decomposition of the solid polymer electrolyte membrane and deterioration of the anode catalyst layer can be effectively suppressed. Additionally, in this embodiment, the host compound having a molecular weight of 300 or more is also added in the anode catalyst layer. Addition of the host compound in the anode catalyst layer in this embodiment allows suppressing movement of the cerium ion and/or the manganese ion in the anode catalyst layer, thereby allowing reducing a bias of concentration in the surface direction. Further, due to its molecular weight range, the host compound in this embodiment does not transfer to the cathode catalyst layer so much, and therefore deterioration of the cathode catalyst by the host compound, such as 18-crown-6-ether, which conventionally occurred, can be suppressed. Therefore, the membrane electrode assembly according to this embodiment allows having excellent durability in addition to excellent power generation performance.

The following describes configurations of this embodiment.

The solid polymer electrolyte membrane has a function of blocking flows of electrons and a gas and moving proton (H⁺) generated in the anode from an anode side catalyst layer to a cathode side catalyst layer. As the solid polymer electrolyte membrane in this embodiment, an ion exchange membrane having known proton conductivity in the technical field can be used. From the aspect of high power generation efficiency and excellent basic property, the solid polymer electrolyte membrane is an ion exchange membrane formed of a perfluorocarbon polymer having sulfonate group in some embodiments. As examples of the solid polymer electrolyte membrane, a membrane made of fluororesin (such as Nafion (produced by DuPont de Nemours, Inc.), FLEMION (produced by AGC Inc.), and Aciplex (produced by Asahi Kasei Corporation)) having sulfonate group as an electrolyte can be used.

The thickness of the solid polymer electrolyte membrane is not specifically limited, and is, for example, from 5 μm to 50 μm from the aspect of improvement in proton conductivity.

The cathode catalyst layer functions as an air electrode (oxygen electrode).

The cathode catalyst layer at least contains an electrode catalyst (also simply referred to as a “catalyst”) and an electrolyte. The electrode catalyst is a metal-supported catalyst in some embodiments. In the metal-supported catalyst, a metal catalyst is supported to a carrier.

As the carrier, the carrier known in the technical field can be used, and the carrier is not specifically limited. Examples of the carrier include a carbon material, such as carbon black, carbon nanotube, and carbon nanofiber; and a carbon compound, such as silicon carbide. One carrier may be used alone, or two or more carriers may be used in combination.

As long as the metal catalyst shows a catalytic action in reaction in an electrode, the metal catalyst is not specifically limited.

Air electrode (cathode): O₂+4H⁺+4e⁻→2H₂O

Hydrogen electrode (anode): 2H₂→4H⁺+4e⁻

The metal catalyst is not specifically limited, and, for example, platinum, palladium, rhodium, gold, argentum, osmium, iridium, or an alloy containing two or more of them can be used. Additionally, the platinum alloy is not specifically limited, and, for example, an alloy of platinum and at least one of aluminum, chrome, manganese, iron, cobalt, nickel, gallium, zirconium, molybdenum, ruthenium, rhodium, palladium, vanadium, tungsten, rhenium, osmium, iridium, titanium, or lead can be used. One metal catalyst may be used alone, or two or more metal catalysts may be used in combination.

While the content of electrode catalyst in the cathode catalyst layer is not specifically limited, for example, the content is from 3 to 40 mass % of the total mass of the catalyst layer.

The electrolyte used for the cathode catalyst layer is an ionomer in some embodiments. The ionomer is also referred to as cation-exchange resin, and is present as a cluster formed of ionomer molecules. The ionomer is not specifically limited, and, for example, the ionomer known in the technical field can be used. Examples of the ionomer include: fluororesin-based electrolyte, such as perfluorosulfonic acid resin; sulfonated plastic-based electrolyte, such as sulfonated polyether ketone, sulfonated polyethersulfone, sulfonated polyether ether sulfone, sulfonated polysulfone, sulfonated polysulfide, and sulfonated polyphenylene; and sulfoalkylated plastic-based electrolyte, such as sulfoalkylated polyether ether ketone, sulfoalkylated polyethersulfone, sulfoalkylated polyetherethersulfone, sulfoalkylated polysulfone, sulfoalkylated polysulfide, and sulfoalkylated polyphenylene. One electrolyte may be used alone, or two or more electrolytes may be used in combination.

The anode catalyst layer functions as a fuel electrode, namely, a hydrogen electrode.

In addition to the electrode catalyst, the anode catalyst layer in this embodiment at least contains an ionomer having sulfonate group, a metal ion selected from cerium ion or manganese ion, and a host compound capable of forming an inclusion compound with the metal ion. The molecular weight of the host compound is 300 or more.

The electrode catalyst is not specifically limited, and, for example, the above-described materials can be used.

The ionomer having the sulfonate group is not specifically limited, and examples of which include polyelectrolyte resin having ionic conductivity, such as a perfluoro sulfonic acid ionomer. Specific examples of the ionomer having the sulfonate group include Nafion and Aquivion (Solvay S.A.).

The metal ion is selected from cerium ion or manganese ion. The cerium ion and the manganese ion function as radical quenching agents. The radical quenching agent allows facilitating transformation of the hydroxyl radical generated from the hydrogen peroxide into hydroxide ion and allows suppressing deterioration of the anode catalyst layer. For example, the reaction of the hydroxyl radical to the hydroxide ion by the cerium ion is as follows.

Ce³⁺+·OH (hydroxyl radical)→Ce⁴⁺+OH⁻ (hydroxide ion)

The cerium ion may have +3 valence or may have +4 valence. The manganese ion may have +3 valence or may have +4 valence.

The cerium salt to obtain the cerium ion is not specifically limited, and examples of which include cerium nitrate, cerium carbonate, cerium acetate, cerium chloride, ceric sulfate, diammonium cerium nitrate, or tetraammonium cerium sulfate. One of cerium salt may be used alone, or two or more cerium salts may be used in combination. The cerium salt may be organic metal complex salt. An example of the organic metal complex salt includes cerium acetylacetonate.

The manganese salt to obtain the manganese ion is not specifically limited, and examples of which include manganese nitrate, manganese carbonate, manganese acetate, manganese chloride, or manganese sulfate. One of manganese salt may be used alone, or two or more manganese salts may be used in combination.

The host compound in this embodiment forms the inclusion compound with the cerium ion or the manganese ion as a guest compound. Additionally, the host compound in this embodiment has the molecular weight of 300 or more.

The inclusion compound in this embodiment means an addition compound having a configuration of the metal ion as the guest compound is included in the host compound. Examples of the host compound forming the inclusion compound include a crown ether compound, a cyclodextrin compound, or a cyclophane compound. One host compound may be used alone, or two or more host compounds may be used in combination.

As long as the host compound in this embodiment is a compound that allows forming the inclusion compound with the metal ion and has the molecular weight of 300 or more, the host compound is not specifically limited. The use of the host compound having the molecular weight of 300 or more allows obtaining a transfer suppression effect, that is, transfer of the host compound from the anode catalyst layer to the cathode catalyst can be suppressed.

The host compound has a cyclic structure in some embodiments. The number of ring members of the ring structure is 15 or more in some embodiments and 18 or more in some embodiments. In one embodiment, the host compound is a crown ether compound in some embodiments. The crown ether compound is a compound having a ring having a repeated structure of (—CH₂—CH₂—Y—) unit or (—CH₂—CH₂—CH₂—Y—) unit, and Y is at least one of hetero atom selected from O, S, N, or P. The crown ether compound traps the metal ions in this ring structure to form the inclusion compound. The number of ring members of the crown ether compound is 15 or more in some embodiments, and 18 or more in some embodiments.

Examples of the crown ether compound include crown ether or a crown ether derivative. Examples of the crown ether having the molecular weight of 300 or more include 21-crown-7-ether and 24-crown-8-ether. In this embodiment, the host compound is a crown ether compound having an aromatic ring or an aliphatic ring in some embodiments. The crown ether compound having the aromatic ring or the aliphatic ring has high hydrophobicity caused by its structure, and therefore is excellent in transfer suppression effect. Examples of the crown ether compound having the aromatic ring or the aliphatic ring include dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, dicyclohexano-24-crown-8-ether, and compounds in which an aromatic ring or an aliphatic ring of these compounds is substituted by at least one substituent selected from a halogen atom (such as a fluorine atom or a bromine atom), a hydroxy group, an amino group, a nitro group, a formyl group, an alkyl group having 1 to 6 carbon atoms (for example, a methyl group, an ethyl group, a propyl group, and a butyl group), a hydroxyalkyl group having 1 to 6 carbon atoms, a carboxyalkyl group having 2 to 7 carbon atoms, and an aryl group having 6 to 14 carbon atoms (for example, a phenyl group). The number of substituents is, for example, from 1 to 6, from 1 to 5, from 1 to 4, from 1 to 3, 1 or 2, or 1. One of the compounds may be used alone, or two or more the compounds may be used in combination.

In the anode catalyst layer in the membrane electrode assembly of this embodiment, at least a part of the host compound and the metal ion form the inclusion compound.

As described above, the membrane electrode assembly of this embodiment has excellent resistance against the hydrogen peroxide or the peroxide radical. Although the reason for improving the resistance is not clear, it is estimated as follows. By containing the cerium ion and/or the manganese ion and its host compound in the anode catalyst layer, at least a part of them forms the inclusion compound. The inclusion compound interacts with the sulfonate group (—SO₃—) of the ionomer in the anode catalyst layer, a part of the sulfonate group is ion-exchanged with the inclusion compound, and thus a structure (for example, a structure in which three sulfonate groups are coordinated to (Ce/the crown ether)³⁺) in which the sulfonate group is coordinated to the inclusion compound of the cerium ion and the host compound is formed. By thus forming the structure, movement of the metal ions, such as the cerium ions, in the surface direction is suppressed, and consequently, the bias of concentration due to the movement of the metal ions is reduced. Therefore, a radical quench effect by the metal ion can be effectively obtained. The host compound used in this embodiment has a comparatively large molecular weight, that is, has the molecular weight of 300 or more, and therefore it is presumed that a resistance against the hydrogen peroxide or the peroxide radical is improved. The case where preliminarily produced inclusion compound is contained in the electrolyte membrane is similarly estimated. The use of the host compound having the large molecular weight reduces transfer of the host compound to the cathode catalyst layer, and therefore deterioration of the cathode catalyst due to the host compound, such as 18-crown-6-ether, which conventionally occurred, can be suppressed. Therefore, the membrane electrode assembly of this embodiment allows providing excellent durability and power generation performance.

In this embodiment, the content of the metal ion and the host compound in the anode catalyst layer is from 0.1 to 20 mass % of the total solid content quantity in the anode catalyst layer in some embodiments. Note that regarding the content, the inclusion compound is regarded as the mixture of the metal ion and the host compound. That is, when the metal ion and the host compound are separately or simply mixed and added in the anode catalyst layer, even when the inclusion compound is generated in the polyelectrolyte, its amount is not considered, and only the total amount of the combined metal ion and the inclusion compound is subject for calculation. In a case where the inclusion compound is preliminarily formed and subsequently the inclusion compound is added in the anode catalyst layer, the amount of the inclusion compound is the total amount of the metal ion forming the inclusion compound and the inclusion compound. Furthermore, in a case where the metal ion not forming the inclusion compound and the host compound are further present except for the metal ion or the host compound forming the inclusion compound, they are also subject for the calculation.

Regarding a relative ratio of the host compound to the metal ion in this embodiment, a mole ratio ([the number of moles of the host compound]/[the number of moles of the metal ion]) of the host compound to the metal ion is, for example, from 0.1 to 10, from 0.2 to 7.5 in some embodiments, and from 0.4 to 5.0 in some embodiments. That is, the content of the host compound is, for example, from 0.1 to 10 moles relative to one mole of the metal ion, from 0.2 to 7.5 moles in some embodiments, and from 0.4 to 5.0 moles in some embodiments. Note that, in this relative ratio as well, similarly to the above description, the inclusion compound is regarded as the mixture of both.

### [Method for Producing Membrane Electrode Assembly]

The catalyst layer can be formed by, for example, a step of preparing catalyst ink (for example, a solid content concentration of approximately 10%) containing an electrode catalyst, an ionomer, and a solvent, a step of applying the catalyst ink over a substrate surface and volatilizing a solvent in the coating film to form a catalyst layer on the substrate surface, and a step of transferring the catalyst layer on the substrate surface to the electrolyte membrane. Additionally, the catalyst layer can also be formed by a method of directly applying the catalyst ink on the solid polymer electrolyte membrane instead of the substrate. Formation of the cathode catalyst layer and the anode catalyst layer on the solid polymer electrolyte membrane allows producing the membrane electrode assembly.

Examples of the application method of the catalyst ink include a spray method, a blade coating method using a doctor blade and an applicator, a die coating method, a reverse roll coater method, and an intermittent die application method.

The anode catalyst layer in this embodiment can be formed in accordance with the production method of the anode catalyst layer known in the technical field except for containing the metal ion and the host compound in the catalyst ink for forming the anode catalyst layer. Specifically, the catalyst ink for forming the anode catalyst layer contains the electrode catalyst, the ionomer having the sulfonate group, the metal ion, the host compound, and a solvent. Each of the metal ion and the host compound may be added separately or may be added in a form of the inclusion compound (complex) of both.

### [Specific Configurations of Membrane Electrode Assembly and Solid Polymer Fuel Cell]

The solid polymer fuel cell includes the membrane electrode assembly (MEA) in which the catalyst layers (electrodes) are assembled to both surfaces of the solid polymer electrolyte membrane as a basic unit. Additionally, in the solid polymer fuel cell, a gas diffusion layer is generally disposed outside the catalyst layer. The gas diffusion layer supplies the catalyst layer with reaction gas and electrons and, for example, a carbon paper and a carbon cloth are used. The catalyst layer is a part serving as a reaction field of electrode reaction.

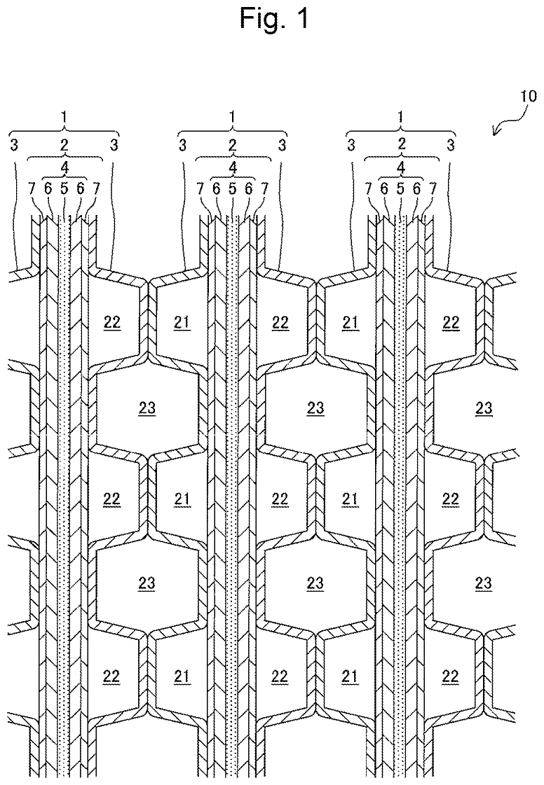

Hereinafter, with reference to FIG. 1, the configurations of the membrane electrode assembly and the solid polymer fuel cell will be described. FIG. 1 is a schematic cross-sectional view for describing the exemplary configuration of the solid polymer fuel cell according to this embodiment, and is a cross-sectional view of the main part of a fuel cell 10 as an example. The solid polymer fuel cell includes a unit cell stacked body configured of an electricity generating body and fuel cell separators disposed on both surfaces of the electricity generating body. A plurality of the unit cells are stacked in the stacking direction, and the respective unit cells are electrically connected in series. As illustrated in FIG. 1, in the fuel cell 10, the plurality of unit cells 1 as the basic unit are stacked. Each of the unit cells 1 is a solid polymer fuel cell that generates an electromotive force by electrochemical reaction between oxidant gas (for example, air) and a fuel gas (for example, hydrogen). The unit cell 1 includes a membrane electrode gas diffusion layer assembly (Membrane Electrode & Gas Diffusion Layer Assembly: MEGA) 2 in which gas diffusion layers (GDLs) 7 are disposed on both sides, and separators 3 in contact with the MEGA 2 so as to partition the MEGA 2. In this embodiment, the MEGA 2 is sandwiched by a pair of the separators 3, 3.

The MEGA 2 includes a Membrane Electrode Assembly (MEA) 4 and the gas diffusion layers 7, 7 disposed on both surfaces of the membrane electrode assembly 4. The membrane electrode assembly 4 is constituted of an electrolyte membrane 5 and a pair of electrodes 6, 6 assembled such that the electrolyte membrane 5 is sandwiched therebetween. The electrolyte membrane 5 is, for example, a proton conductive ion exchange membrane formed by a solid polymer material. The electrode 6 contains, for example, a porous carbon material supporting a catalyst, such as platinum. The electrode 6 disposed on one side of the electrolyte membrane 5 functions as an anode, and the electrode 6 on the other side functions as a cathode. The gas diffusion layer 7 is formed of a conductive member having gas permeability. Examples of the conductive member having gas permeability include a carbon porous body, such as a carbon paper or a carbon cloth, and a metal porous body, such as a metal mesh or foamed metal. In this embodiment, the anode electrode is constituted of an anode catalyst layer, and the cathode electrode is formed of a cathode catalyst layer.

The MEGA 2 is a power generation unit of the fuel cell 10, and the separators 3 are in contact with the gas diffusion layers 7 of the MEGA 2. Additionally, in a case where the gas diffusion layer 7 is absent, the membrane electrode assembly 4 is a power generation unit, and in this case, the separators 3 are in contact with the membrane electrode assembly 4. Accordingly, the power generation unit of the fuel cell 10 includes the membrane electrode assembly 4 and is in contact with the separators 3.

The separator 3 is a plate-shaped member having a metal substrate (for example, a stainless steel substrate). The metal substrate is excellent in, for example, conductive property and gas impermeability. In FIG. 1, the surface on the power generation unit side of the separator 3 abuts on the gas diffusion layer 7 of the MEGA 2, and the other surface abuts on the other adjacent separator 3.

A gas flow channel 21 defined between the gas diffusion layer 7 on a side of one electrode (namely, the anode electrode) 6 and the separator 3 is a flow passage through which a fuel gas flows. A gas flow channel 22 defined between the gas diffusion layer 7 on a side of the other electrode (namely, the cathode electrode) 6 and the separator 3 is a flow passage through which an oxidant gas flows. When the fuel gas is supplied to the one gas flow channel 21 opposed to the gas flow channel 22 via the cell 1 and the oxidant gas is supplied to the gas flow channel 22, an electrochemical reaction occurs inside the cell 1 to generate an electromotive force.

Furthermore, one cell 1 and another cell 1 adjacent to the one cell 1 are disposed such that the anode electrode 6 and the cathode electrode 6 face one another. The top portions on a back surface side of the separator 3 disposed along the anode electrode 6 of the one cell 1 are in surface contact with the top portions on the back surface side of the separator 3 disposed along the cathode electrode 6 of another one cell 1. A coolant (for example, water) to cool the cells 1 flows through a space (cooling agent flow channel) 23 defined between the separators 3, 3 that are in surface contact between the adjacent two cells 1.

### EXAMPLES

This embodiment will be described below using the examples.

### Example 1

### (Formation of Cathode Catalyst Layer)

A metal-supported catalyst as an electrode catalyst was dispersed in an ionomer solution (DE2020) containing water and ethanol using a bead mill to prepare catalyst ink. A mass ratio (water/ethanol) of water to the ethanol in the catalyst ink was approximately 1. The obtained catalyst ink was applied and dried on a polytetrafluoroethylene sheet to form a cathode catalyst layer.

A weight of Pt in the cathode catalyst layer was 0.2 mg/cm², and a mass ratio (I/C) of the ionomer to the carbon was 1.0. As catalyst particles, 30 wt % Pt on Vulcan (registered trademark) (TEC10V30E, produced by Tanaka Kikinzoku Kogyo) was used.

### (Formation of Inclusion Compound (Complex))

21-crown-7-ether (21CRE) (3.08 g, 0.01 mol) and cerium(iii) nitrate hexahydrate (4.34 g, 0.01 mol) were weighted with a 100 mL of an eggplant flask, ethanol (20 mL) and water (20 mL) were added, and the resultant was stirred for 24 hours at room temperature. Afterwards, after removal of the solution by an evaporator, vacuum drying was performed at 60° C. for one hour to obtain a white solid. By confirming that a peak derived from an ether group was shifted to a low wave number side by FT-IR, it was confirmed that the CRE and the Ce formed an inclusion compound.

### (Formation of Anode Catalyst Layer)

As the electrode catalyst, 60 wt % Pt/Ketjen (registered trademark) was used. The electrode catalyst and the complex were dispersed in an ionomer solution (DE2020) containing water, ethanol, and Nafion (registered trademark) to prepare catalyst ink. This catalyst ink was applied and dried on a polytetrafluoroethylene sheet to form an anode catalyst layer.

The weight of Pt of the anode catalyst layer was 0.1 mg/cm², and the cerium ion concentration was 4 μg/cm². As described above, the host compound was contained at the ratio of Ce:ligand=1:1 mol. The mass ratio (I/C) of the ionomer to the carbon was 1.0.

### (Production of Membrane Electrode Assembly)

Each of the obtained cathode catalyst layer and anode catalyst layer was heat-transferred on both surfaces of a Nafion (registered trademark) membrane (NR211) to produce a membrane electrode assembly E1. Conditions for heat transfer were 140° C., 50 kgf/cm² (4.90 MPa), and 5 min. An electrode area of the membrane electrode assembly for initial performance test was 1 cm×1 cm (1 cm²). An electrode area of the membrane electrode assembly for a durability test was 3.6 cm×3.6 cm (12.96 cm²). This membrane electrode assembly was sandwiched by a paper diffusion layer with water-repellent layer (GDL) to produce a test cell.

[Example 2]: Except that 24-crown-8-ether (24CRE) (0.01 mol) was used instead of 21CRE (0.01 mol), a membrane electrode assembly E2 was produced similarly to Example 1.
[Example 3]: Except that benzo-18-crown-6-ether (B18CRE) (0.01 mol) was used instead of 21CRE (0.01 mol), a membrane electrode assembly E3 was produced similarly to Example 1.
[Example 4]: Except that dibenzo-18-crown-6-ether (DB18CRE) (0.01 mol) was used instead of 21CRE (0.01 mol), a membrane electrode assembly E4 was produced similarly to Example 1.
[Example 5]: Except that dicyclohexano-18-crown-6-ether (DCH18CRE) (0.01 mol) was used instead of 21CRE (0.01 mol), a membrane electrode assembly E5 was produced similarly to Example 1.
[Example 6]: Except that 0.004 mol of B18CRE was added, a membrane electrode assembly E6 was produced similarly to Example 3.
[Example 7]: Except that 0.050 mol of B18CRE was added, a membrane electrode assembly E7 was produced similarly to Example 3.
[Comparative Example 1]: Except that 15-crown-5-ether (15CRE) (0.01 mol) was used instead of 21CRE (0.01 mol), a membrane electrode assembly C1 was produced similarly to Example 1.
[Comparative Example 2]: Except that 18-crown-6-ether (18CRE) (0.01 mol) was used instead of 21CRE (0.01 mol), a membrane electrode assembly C2 was produced similarly to Example 1.
[Comparative Example 3]: Except that a host compound was not contained, a membrane electrode assembly C3 was produced similarly to Example 1.

### [Evaluations]

### (Initial Performance Test)

Current-voltage characteristics of the test cells (electrode area: 1 cm²) were evaluated under the following conditions. The following Table 1 shows voltage values at 1.0 A/cm² as the results. Low humidify environment (30% RH), sweep rate: 20 mA/s, cell temperature: 90° C., pressure: 150 kPa (abs), cathode gas type: air, cathode gas flow rate: 2.0 L/min, anode gas type: hydrogen, anode gas flow rate: 0.5 L/min

### (Durability Test)

The test cell (electrode area: 12.96 cm²) was embedded into an electric generation cell, and durability test was conducted under low humidify environment (90° C., 30% RH). In the durability test, the cell temperature was set to be 90° C., hydrogen/air were supplied, and an initial property and the property after durability test load of the solid polymer fuel cell at the current density of 0.05 A/cm² were evaluated. Each of the hydrogen and the air was humidified such that the anode side had a dew point of 67° C. and the cathode side had a dew point of 67° C. and was supplied in the cell, and a relationship between a cell voltage at the beginning of the operation, the elapsed time after the operation start, and the cell voltage was measured. Table 1 shows the results. Additionally, under the above-described cell evaluation conditions, the cell voltage at the beginning of the operation and the cell voltage after the elapse of 300 hours after the operation start were measured.

TABLE 1

| | | | | Initial | Durability Test | | |
|---|---|---|---|---|---|---|---|
| | | | | Performance | | Voltage at | |
| | Host Compound | | | Test | Voltage at | 0.05 A/cm² (V) | |
| | | Molecular | Mol Mass | Voltage at | 0.05 A/cm² (V) | (After Elapse | Percentage |
| | Name | Weight | Ratio to Ce | 1.0 A/cm² (V) | (Initial) | of 300 Hours) | of Change (%) |
| Example 1 | 21CRE | 308 | 1.0 | 0.60 | 0.83 | 0.79 | 95 |
| Example 2 | 24CRE | 352 | 1.0 | 0.62 | 0.84 | 0.79 | 94 |
| Example 3 | B18CRE | 312 | 1.0 | 0.65 | 0.85 | 0.82 | 96 |
| Example 4 | DB18CRE | 360 | 1.0 | 0.66 | 0.85 | 0.82 | 96 |
| Example 5 | DCH18CRE | 364 | 1.0 | 0.66 | 0.85 | 0.83 | 98 |
| Example 6 | B18CRE | 312 | 0.4 | 0.68 | 0.86 | 0.76 | 88 |
| Example 7 | B18CRE | 312 | 5.0 | 0.63 | 0.82 | 0.76 | 93 |
| Comparative | 15CRE | 220 | 1.0 | 0.52 | 0.79 | 0.68 | 86 |
| Example 1 | | | | | | | |
| Comparative | 18CRE | 264 | 1.0 | 0.55 | 0.82 | 0.75 | 91 |
| Example 2 | | | | | | | |
| Comparative | — | — | — | 0.68 | 0.86 | 0.65 | 76 |
| Example 3 | | | | | | | |

Upper limit values and/or lower limit values of respective numerical ranges described in this specification can be appropriately combined to specify an appropriate range. For example, upper limit values and lower limit values of the numerical ranges can be appropriately combined to specify an appropriate range, upper limit values of the numerical ranges can be appropriately combined to specify an appropriate range, and lower limit values of the numerical ranges can be appropriately combined to specify an appropriate range.

While the embodiment has been described in detail, the specific configuration is not limited to the embodiment. Design changes within a scope not departing from the gist of the disclosure are included in the present disclosure.

### DESCRIPTION OF SYMBOLS

1 Cell
2 MEGA (power generation unit)
3 Separator (fuel cell separator)
4 Membrane electrode assembly (MEA)
6 Electrode
7 Gas diffusion layer
10 Fuel cell
21, 22 Gas flow channel
31 Metal substrate
32 Tin oxide film

What is claimed is:

1. A membrane electrode assembly comprising:
a solid polymer electrolyte membrane;
an anode catalyst layer disposed on one surface of the solid polymer electrolyte membrane; and
a cathode catalyst layer disposed on the other surface of the solid polymer electrolyte membrane,
wherein the anode catalyst layer at least comprises an electrode catalyst, an ionomer having sulfonate group, a metal ion selected from cerium ion or manganese ion, and a host compound capable of forming an inclusion compound with the metal ion, and
wherein the host compound has a molecular weight of 300 or more.

2. The membrane electrode assembly according to claim 1,
wherein the host compound is a crown ether compound having a ring structure, and a number of ring members of the ring structure is 15 or more.

3. The membrane electrode assembly according to claim 2,
wherein the host compound is a crown ether compound having an aromatic ring or an aliphatic ring.

4. The membrane electrode assembly according to claim 3,
wherein the crown ether compound is at least one compound selected from the group consisting of dibenzo-15-crown-5-ether, benzo-18-crown-6-ether, dibenzo-18-crown-6-ether, benzo-21-crown-7-ether, dibenzo-21-crown-7-ether, benzo-24-crown-8-ether, dibenzo-24-crown-8-ether, cyclohexano-18-crown-6-ether, cyclohexano-21-crown-7-ether, cyclohexano-24-crown-8-ether, dicyclohexano-18-crown-6-ether, dicyclohexano-21-crown-7-ether, dicyclohexano-24-crown-8-ether, and compounds in which an aromatic ring or an aliphatic ring of these compounds is substituted by at least one substituent selected from a halogen atom, a hydroxy group, an amino group, a nitro group, a formyl group, an alkyl group having 1 to 6 carbon atoms, a hydroxyalkyl group having 1 to 6 carbon atoms, a carboxyalkyl group having 2 to 7 carbon atoms, and an aryl group having 6 to 14 carbon atoms.

5. The membrane electrode assembly according to claim 1,
wherein the ionomer is a perfluoro sulfonic acid polymer.
